(19) United States
(12) Patent Application Publication
(10) Pub. No.: US 2025/0204534 A1
(43) Pub. Date: Jun. 26, 2025

(54) Composition for controlling insect pest comprising microencapsulation-based spray drying formulation of Btk IMBL-B9 as an active ingredient

(71) Applicant: JAN153 BIOTECH INC., Gwangju (KR)

(72) Inventors: Nanhee YU, Gwangju (KR); Euna CHOI, Daejeon (KR); Jonghwi BAEK, Gwangju (KR); Seonhwa KIM, Gwangju (KR)

(21) Appl. No.: 18/961,591

(22) Filed: Nov. 27, 2024

(30) Foreign Application Priority Data
Dec. 20, 2023 (KR) 10-2023-0186973

(51) Int. Cl. A01N 63/23; A01N 25/28; A01P 7/04

(52) U.S. Cl. CPC A01N 63/23; A01N 25/28; A01P 7/04

(57) ABSTRACT

The present invention relates to a composition for controlling insect pest comprising microencapsulation-based spray drying formulation of Btk IMBL-B9 as an active ingredient. Specifically, when a microencapsulation-based spray drying formulation was prepared targeting Btk IMBL-B9 (Bacillus thuringiensis subsp. kurstaki IMBL-B9), it improves the spore-crystal complex stability to increase the spore survival rate and enhance the storage stability as compared with the non-encapsulated spray drying formulation. In addition, the encapsulated spray drying formulation of Btk IMBL-B9 was verified to have excellent insecticidal activity against Spodoptera frugiperda and Plutella xylostella, and can be used more effectively to prevent or control the insect pests.

### CROSS-REFERENCE TO RELATED APPLICATION(S)

This application claims the benefit of Korean Patent Application No. 10-2023-0186973, filed on Dec. 20, 2023, with the Korean Intellectual Property Office, the disclosure of which is incorporated herein by reference in its entirety.

### TECHNICAL FIELD

The present invention relates to a composition for controlling insect pest comprising a microencapsulation-based spray drying formulation of Btk IMBL-B9 as an active ingredient

### BACKGROUND

Effective pest controlling strategies are of very great importance beyond simple crop protection, as they contribute to agricultural development, such as increasing yields due to reduction of crop losses, improving food quality, and increasing food production and contributing to food security. The use of chemicals for controlling inset pest causes problems such as disruption of the agricultural ecosystems, environmental pollution, and mammalian toxicity. Therefore, research and development of biological pest controlling agents have been actively conducted to reduce the use of harmful chemicals and insecticides through environmentally friendly pest control using biological formulations. New biological pest controlling products, including microbial-based insecticides, have appeared on the market. Among these microbial biological insecticides, Bacillus thuringiensis (hereinafter, abbreviated as Bt) is a spore-forming Gram-positive bacterium that produces insecticidally active crystal proteins containing Cry, Cyt, and Vip encoded by the Cry, Cyt, and Vip genes, which are endotoxin proteins that are toxic to insects, respectively. The endotoxin proteins are activated through the process of dissolution and decomposition in the midgut of target pests, and act as active toxins that destroy the midgut membrane of the pests, ultimately causing the death of the pests. Since this endotoxin protein is non-toxic except for target pests, various research and development have been conducted for a long time, and many countries around the world are currently developing and selling it as a microbial insecticide for agricultural and sanitary pest control.

Bt-based biological insecticides were used to control lepidopteran pests in farms starting in France in the late 1920s, and were later produced as commercial products in France in 1938. Bt insecticide products were registered in the United States in 1958, and microbial insecticides began to be sold in the United States after 1960. At that time, various Bt insecticides were developed to control lepidopteran, dicotyledon, and coleopteran pests, and Bt insecticide sales continue to increase worldwide every year.

However, Bt-based biological insecticides have the disadvantages in that only specific pests are controlled by a narrow host spectrum, and if the same product is used continuously for a long period of time, resistant pests are generated, thereby reducing the efficacy, and have a short shelf life. Researchers are trying to solve this problem by isolating and securing Bt microbial strains from various places around the world and selecting new Bt strains with a wide host spectrum and high insecticidal activity, but it is very difficult to discover excellent new Bt strains.

In 2021, various Bt strains were isolated and secured in the South Korea. Bt subsp. kurstaki IMBL-B9 (Btk IMBL-B9) strains with high potential for development as biologically controlling agents exhibiting excellent insecticidal activity against polyphagous pests such as Spodoptera frugiperda and Spodopfera emigua belonging to Noctuidae, and Plutella xylostella belonging to Plutellidae were selected (Park et al., 2022, Pest Manag. Sci. 78, 2976-2984).

The selected Btk IMBL-B9 strain has a total of eight insecticidally active crystal protein genes crylAa, crylAc, crylBe, crylHa, cry2Aa, cry2Ab, cry2Ah, and crylEa, as well as one plant insecticidal protein gene vip134Aa. The new Btk IMBL-B9 strain showed excellent insecticidal activity against a wide range of host lepidopteran pests, including the Nocturnidae and Plutellinae. The results of a study comparing the insecticidal activity of Bt subsp. aizawai NT0423 (Bta NT0423) and Bt subsp. kurstaki HD-1 (Btk HD-1) strains, which are effective microorganisms in products previously developed and sold as Bt products, showed that the LC₅₀ values (10⁶ CFU/mL) of the Btk IMBL-B9 strain were 4.9 times, 5.6 times, and 34.7 times lower than those of the Bta NT0423 strain against Spodoptera frugiperda, Beet armyworm, and Plutella xylostella, respectively, and 19.3 times, 21.8 times, and 1.4 times lower than those of the Btk HD-1 strain, respectively. Based on the above results, the Btk IMBL-B9 strain suggests that it has high potential for the development of Bt insecticides capable of controlling a wide range of butterfly-necklace insect.

Bt insecticides have a mechanism of controlling insect pests by destroying the midgut membrane of target pests through the use of endotoxin proteins, which are insecticidally active crystal proteins. The stability and durability of the insecticidally active crystal protein are extremely important when applied in agricultural fields, so that the stability and sustainability of the insecticidally active crystal protein are very important when applied to agricultural fields. Therefore, in order to develop Bt insecticides, it is essentially required to develop a formulation for stabilizing the insecticidally active crystal protein that can overcome environmental influences.

The present invention attempted to develop a microencapsulation-based spray drying formulation process to stabilize the insecticidally active crystal protein of the Btk IMBL-B9 strain, which showed excellent insecticidal activity against a wide range of host lepidopteran pests, including the Nocturnidae and Plutellinae. The purpose of the present invention is to 1) develop a microencapsulation-based spray dried formulation of Bkt IMBL-B9 using a mixture of gum arabic, starch and maltodextrin, 2) investigate the spore survival rate and storage stability of the formulation, 3) investigate the insecticidal activity of the formulation against Plutella xylostella larvae in vitro, and 4) evaluate the efficacy of the pest control against Spodoptera frugiperda and Putella xylostella pests.

As a prior art related to pest control, Korean Patent Registration No. 2389895 discloses ‘Pest control composition comprising saccharin, a salt thereof, or saccharic acid’, and Korean Patent Registration No. 2207732 discloses ‘Metarhizium anisopliae FT319 strain or a microbial agent for controlling a Plutella xylostella larva containing the same’. However, the ‘composition for controlling insect pest comprising microencapsulation-based spray drying formulation of Btk IMBL-B9 as an active ingredient’ of the present invention has not been disclosed yet.

### DETAILED DESCRIPTION OF THE INVENTION

### Technical Problem

The present invention has been derived in response to the above-mentioned demands, and an object of the present invention is to provide a composition for controlling insect pest comprising microencapsulation-based spray drying formulation of Btk IMBL-B9 as an active ingredient. Specifically, it has been confirmed that when a microencapsulation-based spray drying formulation was prepared targeting Btk IMBL-B9 (Bacillus thuringiensis subsp. kurstaki IMBL-B9), the spore survival rate was maintained high, the storage stability was excellent, and the insecticidal activity against Spodoptera frugiperda and Plutella xylostella was excellent as compared with a non-encapsulated spray drying formulation, thereby completing the present invention.

### Technical Solution

In order to achieve the above object, the present invention provides a microencapsulation-based spray drying formulation which is prepared by adding a coating mixture consisting of gum arabic, starch and maltodextrin to a Bacillus thuringiensis strain, followed by stirring and spray drying.

The present invention also provides a composition for controlling insect pest, comprising the microencapsulation-based spray drying formulation as an active ingredient.

In addition, the present invention provides a method for controlling insect pest, comprising treating an effective amount of the composition for controlling insect pest to a plant, a plant seed, or a cultivation area.

Further, the present invention provides a method for preparing a microencapsulation-based spray drying formulation, the method comprising: (1) a step of fermenting a Bacillus thuringiensis subsp. kurstaki IMBL-B9 strain to obtain a fermentation liquid, collecting a spore-crystal complex from the fermentation liquid, and concentrating it; (2) a step of adding a coating mixture of gum arabic, starch and maltodextrin in a weight ratio of 0.5 to 10.0:0.5 to 10.0:0.5 to 10.0 to the concentrated spore-crystal complex, and stirring the mixture; and (3) a step of spray-drying the resulting mixture using a spray drying device at an inlet temperature of 130˜150° C. and an outlet temperature of 80˜90° C., after the stirring.

### Advantageous Effects

The present invention relates to a composition for controlling insect pest comprising microencapsulation-based spray drying formulation of Btk IMBL-B9 as an active ingredient. Specifically, when a microencapsulation-based spray drying formulation was prepared targeting Btk IMBL-B9 (Bacillus thuringiensis subsp. kurstaki IMBL-B9), it has the properties of maintaining high spore survival rate, excellent storage stability, and excellent insecticidal activity against Spodoptera frugiperda and Plutella xylostella, as compared with the non-encapsulated spray drying formulation.

### BRIEF DESCRIPTION OF THE DRAWING

FIG. 1 is a photograph of micro-encapsulated spray drying formulation of Btk IMBL-B9 particles taken with a Field Emission Scanning Electron Microscope (FE-SEM).

FIG. 2 shows the results of confirming the spore survival rate of the spray drying formulation of Btk IMBL-B9 through microencapsulation-based spray drying. a and b mean that there is a statistically significant difference in the spore survival rate between the non-encapsulated spray drying formulation of Btk IMBL-B9 and the encapsulated spray drying formulation of Btk IMBL-B9, which means p<0.05.

FIG. 3 shows the results of confirming the spore survival rate of the spray drying formulation of Btk IMBL-B9 through microencapsulation-based spray drying. XenTari® is a positive control group treated with a commercially available Bt insecticide product.

FIG. 4 shows the SDS-PAGE gel images of the insecticidally active crystal protein of the spray drying formulation of Btk IMBL-B9 through microencapsulation-based spray drying. M is a protein size marker, and lanes 0˜6 represent storage weeks at 54±2° C.

FIG. 5 shows the results of confirming the insecticidal activity against 3-week-old Plutella xylostella larvae in a diluent liquid in which encapsulated and non-encapsulated spray drying formulations of Btk IMBL-B9 stored at 54±2° C. for 6 weeks were diluted to 1/100,000 and 1/200,000. Control is the control group treated with distilled water, and XenTari® is a positive control group treated with a commercially available Bt insecticide product. a to e indicate that there is a statistically significant difference in the insecticidal activity between non-encapsulated Btk IMBL-B9 and encapsulated Btk IMBL-B9, which means p<0.005.

FIG. 6 shows the results of confirming the status of cabbage plants infected with 3-week-old larvae of Plutella xylostella and Spodoptera frugiperda on the 7th day after treatment with the microencapsulation-based spray drying formulation of Btk IMBL-B9 of the present invention. Control is a control group treated with distilled water, and XenTari® is a positive control group treated with a commercially available Bt insecticide product.

FIG. 7 shows the results of confirming the status of cucumber plants infected with 3-week-old larvae of Spodoptera frugiperda on the 7th day after treatment with the microencapsulation-based spray drying formulation of Btk IMBL-B9 of the present invention.

### DETAILED DESCRIPTION OF THE EMBODIMENTS

In order to achieve the object of the present invention, the present invention provides a microencapsulation-based spray drying formulation which is prepared by adding a coating mixture consisting of gum arabic, starch and maltodextrin to a Bacillus thuringiensis strain, followed by stirring and spray drying.

The Bacillus thuringiensis is preferably Btk IMBL-B9 (Bacillus thuringiensis subsp. kurstaki IMBL-B9), but is not limited thereto.

The Bacillus thuringiensis is preferably one in which a Bacillus thuringiensis strain is fermented to obtain a fermentation liquid, a spore-crystal complex is collected from the fermentation liquid and concentrated, but is not limited thereto.

The coating mixture may be a mixture of gum arabic, starch and maltodextrin in a weight ratio of 0.5˜10.0:0.5˜10.0:0.5˜10.0, preferably at a weight ratio of 1:1:1, but is not limited thereto.

The spray drying may be carried out using a spray drying device at an inlet temperature of 130˜150° C. and an outlet temperature of 80˜90° C.

In addition, the present invention provides a composition for controlling insect pest, comprising the microencapsulation-based spray drying formulation as an active ingredient.

The insect pest may be Lepidoptera pest, and preferably, it may be at least one selected from the group consisting of Noctuidae, Plutellidae, Crambidae, Pyraloidea, Gelechiidae, Erebidae, Cossoidae, Sesildae, Hepialidae, Hesperiidae and Pieridae. More preferably, the insect pest may be at least one selected from the group consisting of Spodoptera frugiperda, Spodoptera exigua, Plutella xylostella, Noctua albidilinea, Mythima separata, Heliothis assulta, Conogethes punctiferalis, Chilo suppressalis, Scrobipalpa salinella, Hyphantria cunea, Synanthedon bicingulata, Endoclyta excresecns, Paraara auttantus and Pieris rapae. Most preferably, the insect pest may be Spodotera frugiferda, Spodoptera exigua or Plutella xylostella, but is not limited thereto.

The composition for controlling insect pest of the present invention may be prepared in any one formulation selected from solids, granules, powders, liquids, aerosols, sprays, extracts, pastes, fluid extracts, emulsions, suspensions, capsules, liquid wettable powders, granular powders, microgranules, oil, gel-type formulation, smoker, and fumigants, depending on the purpose of use or application use, but is not limited thereto.

In addition, the composition for controlling insect pest of the present invention may be used together with, or separately from, other insecticides, nematicides, acaricides, bactericides, fungicides, herbicides, plant growth regulators, synergists, fertilizers, soil conditioners, etc., or simultaneously.

In the composition for controlling insect pest of the present invention, the composition may be used alone, but is not particularly limited thereto, and may further include an appropriate diluent or excipient depending on the formulation and/or purpose of use of the composition. The excipient may be a common material depending on the formulation, and when formulated, a filler, an extender, an emulsifier, a dispersant, a wetting agent, a disintegrant, or a surfactant may be used. Representative diluents or excipients may include water, potassium oleate, potassium bicarbonate, phenethyl benzoate, phenethyl propionate, dextrin, lactose, propylene glycol, polypropylene glycol, polyvinylpyrrolidone, sodium lignosulfonate, Tween 80, oleic acid, sorbic acid, liquid paraffin, saline solution, etc.

In addition, the present invention provides a composition for controlling insect pest, comprising treating an effective amount of the composition for controlling insect pest to a plant, a plant seed, or a cultivation area.

In the method for controlling insect pest of the present invention, the composition is a composition comprising a microencapsulation-based spray drying formulation of Bacillus thuringiensis as an effective ingredient. The Bacillus thuringiensis strain is as described above.

Further, the treatment may be carried out by uniformly diluting a composition containing an effective amount of a microencapsulation-based spray drying formulation of Bacillus thuringiensis with water to control insect pests and then directly spraying the composition onto the plant using an appropriate spraying device such as a power sprayer. Alternatively, the treatment can be carried out by immersing or irrigating, i.e. spraying, the composition comprising an effective amount of a microencapsulation-based spray drying formulation of Bacillus thuringiensis onto the plant or the seed of the plant. In the case of the immersion method, the composition can be poured on the soil around the plant or the seeds can be immersed in the composition. The plants that can be applied to the method of the present invention are not particularly limited.

The ‘effective amount’ as used herein means an amount of a composition that is sufficient to control insect pests on cultivated plants or not causing substantial damage to the treated plants. This amount can vary within a wide range and depends on various factors, the specific type and condition of the cultivated plants treated, the habitat, or climate conditions.

In the method according to an embodiment of the present invention, the composition for controlling insect pest and the insect pest are as described above.

The plant refers to a plant species that can be inhabited by Lepidoptera pests. The Lepidoptera pest is as described above.

In addition, the present invention provides a method for preparing a microencapsulation-based spray drying formulation, the method comprising:
(1) a step of fermenting a Bacillus thuringiensis strain to obtain a fermentation liquid, collecting a spore-crystal complex from the fermentation liquid, and concentrating it;
(2) a step of adding a coating mixture of gum arabic, starch and maltodextrin in a weight ratio of 0.5˜10.0:0.5˜10.0:0.5˜10.0 to the concentrated spore-crystal complex, and stirring the mixture; and
(3) a step of spray-drying the resulting mixture using a spray drying device at an inlet temperature of 130˜150° C. and an outlet temperature of 80˜90° C., after the stirring.

The Bacillus thuringiensis strain of the step (1) is as described above.

Hereinafter, the present invention will be described in detail by way of examples. However, the following examples are for illustrative purposes only, and are not intended to limit the scope of the present invention.

### [Materials and Methods]

### 1. Fermentation of Btk IMBL-B9

A single colony of Btk IMBL-B9 (Bacillus thuringiensis subsp. kurstaki IMBL-B9) was inoculated into a 250 ml Erlenmeyer flask containing 50 ml of sterilized TSB (Tryptic Soy-Broth, Becton Dickinson and Company, ML, USA) medium, and shaking culture was carried out at 30 t, 220 rpm for 24 hours to secure the seed culture. A 12 l medium B (glucose 15 g, soybean meal 10 g, yeast extract 2 g, peptone 2 g, MgSO₄·7H₂O 0.3 g, ZnSO₄·7H₂O 0.02 g, FeSO₄·7H₂O 0.02 g, distilled water 1 l) sterilized in a 50 l fermenter was inoculated with 1% (v/v) of the seed culture, and fermentation was performed in batch mode for 96 hours under the conditions of 301° C., 500 rpm, aeration rate 1 vvm, and Antifoam 204 (Sigma-Aldrich, Seoul, Republic of Korea) with 0.7% concentration to form spores and insecticidally active crystal proteins.

### 2. Preparation of Btk IMBL-B9 Spore-Crystal Complex

The resulting fermentation liquid was centrifuged at 14,000 rpm using a tubular separator centrifuge (A/T1250, Hanin Sci-Med Co., Ltd, Daejeon, Republic of Korea) to obtain 10-fold concentrated spore-crystal complex. 15% of the coating material mixture (Gum Arabic:Maltodextrin:Starch=1:1:1) was added to 1 l of spore-crystal complex (10¹⁰ CFU/g), and stirred at 300 rpm using a stirrer (MS5050D; Misung S&I, Daejeon, Republic of Korea) for 20 minutes.

### 3. Microencapsulation-Based Spray Drying Formulation

A mixture of spore-crystal complex suspensions containing coating materials for microencapsulation and a spore-crystal complex suspension without coating materials for non-encapsulation were spray-dried using a laboratory spray drying device (KLSD-1500, Koreamedi Co., Ltd, Daegu, Republic of Korea) at an inlet temperature of 140° C., an outlet temperature of 80˜90° C., and a flow rate of 7 ml/min. The microencapsulated spray drying formulation of Btk IMBL-B9s and the non-encapsulated spray drying formulation were collected in a cyclone, transferred to sealed containers, and stored for further analysis.

### 4. Field Emission Scanning Electron Microscopy (FE-SEM)

Using FE-SEM (FESEM HITACHI S-4800), the microencapsulated spray drying formulation of Btk IMBL-B9 and the non-encapsulated spray drying formulation powder samples were fixed to a stub using a sticky carbon paper, coated with platinum, and the appearance of the powders was observed under a microscope.

5. Spore Survival Rate after Spray Drying

The spore survival rate was determined as the ratio of the number of viable spores after spray drying to the number of viable spores before spray drying. The spore survival rate was expressed using the following Equation.

$$Survival rate ( \% ) = \frac{N}{{N}_{0}} \times 100$$

(in the Equation, N represents the log of CFU/g after the spray-drying process, and N₀ represents the log of CFU/g before the spray-drying process).

### 6. Storage Stability

Each sample of microencapsulated spray drying formulation of Btk IMBL-B9 and non-encapsulated spray-dried formulation, and a commercially available Bt insecticide product, XenTari® as a positive control group, were stored at 54° C. for 6 weeks, and samples stored for 0, 2, 4, and 6 weeks were used. The spore survival rate was evaluated by adding 1 g of the microencapsulated and non-encapsulated spray drying formulations and XenTari® samples stored for different times to 9 nL of phosphate buffered saline (PBS) solution and diluting them through vortex stirring for 3 minutes. Then, serial dilution liquids were prepared using the solution, which were then smeared on sterilized 1/2 NA (Nutrient agar; Becton, Dickinson and Company) medium, and after 24 hours of static culture, single colonies were counted, and the storage stability of the formulations was evaluated using the Equation of the spore survival rate.

### 7. SDS-PAGE Analysis

To compare the insecticidally active crystal protein content of the microencapsulated spray drying formulation of Btk IMBL-B9 with that of the commercially available Bt insecticide product, XenTari® (a biological insecticide developed using Bt aizawai ABTS-1857 as an effective microorganism), 10 mg of each was taken and added to 10 mL of IX PBS solution, vortexed for 1 minute, and diluted. Each diluent liquid was mixed with Laemmli sample buffer, boiled for 5 minutes, loaded onto a 12˜15% SDS-PAGE gel, electrophoresed, and analyzed for the insecticidally active crystal protein.

### 8. Insect Moth Rearing

Plutella xylostella was obtained from the Jeollanam-do Agricultural Research and Extension Services, Eco-friendly Agriculture Research Institute (Naju-si, Republic of Korea), and Brassica napus was used as a host plant for larval food and adult reproduction. Spodoptera frugiperda was obtained from Jeonbuk National University, and both moths can reproduce with artificial diet as described in previously reported references (Park et al., 2022, Pest Manag. Sci. 78, 2976-2984). All larvae used in the present invention were reared in an insect rearing room at 25° C., 70% relative humidity, and a 16-hour light/8-hour dark cycle.

### 9. Indoor Insecticidal Activity Bioassay

The insecticidal activity of microencapsulated spray drying formulation of Btk IMBL-B9s and non-encapsulated spray drying formulation stored at 54° C. for 6 weeks, and a commercially available Bt insecticide product XenTari® as a positive control against 7-week-old larvae of Plutella xylostella was investigated. The microencapsulated and non-encapsulated spray drying formulation and XenTari® were prepared as 1/100,000-fold and 1/200,000-fold diluted liquids, respectively, and cabbage leaves with a diameter of 5 cm were immersed in the diluted liquids, dried, and placed in a breeding dish. Ten 3-week-old larvae of the diamondback moth were added, and the larval mortality rate was recorded after 48 hours. The untreated group was immersed in distilled water with cabbage leaves. All treated groups were carried out independently three times.

### 10. Greenhouse Study

A controlled greenhouse experiment was conducted at the Rural Development Administration using 6-leaf cabbage and 4-leaf cucumber plant pots. A completely randomized design was performed with three plant ports per a treatment group. The 6-leaf cabbage plant pots were treated with the first foliar spray of microencapsulated spray drying formulation of Btk IMBL-B9 and a 1/1,000-fold diluted liquid of the commercially available bioinsecticide XenTari® as a positive control, and 20 three-week-old larvae of Plutella xylostella and Spodopfera frugiperda were inoculated per pot. After 3 days, the second foliar spray of microencapsulated spray drying formulation of Btk IMBL-B9 and a 1/1,000-fold diluted liquid of XenTari® was applied. The 4-leaf cucumber plant pots were treated with a primary agent in the same manner as above, and 20 3-week-old larvae of Spodoptera frugiperda were inoculated per pot, and the secondary agent was applied after 3 days. The results of the greenhouse experiment were observed 7 days after the primary agent treatment.

### 11. Statistical Analysis

Statistical analysis was performed using one-way ANOVA using SPSS Statistics version 20 (SPSS Inc., Chicago, IL, USA). Multiple comparisons of means were calculated through post-hoc tests using Scheffe's method. AP value of less than 0.05 was considered statistically significant.

### Example 1. Microencapsulated Spray Drying Formulation of Btk IMBL-B9

In the present invention, in order to develop a Btk IMBL-B9 formulation process by spray drying at a high temperature, Btk IMBL-B9 was encapsulated using gum arabic, starch and maltodextrin coating materials to protect and/or increase the viability of Btk IMBL-B9 spores and the stability of the spore-crystal complex. And, the powder particles of the encapsulated spray drying formulation of Btk IMBL-B9 were analyzed by field emission scanning electron microscopy (FE-SEM).

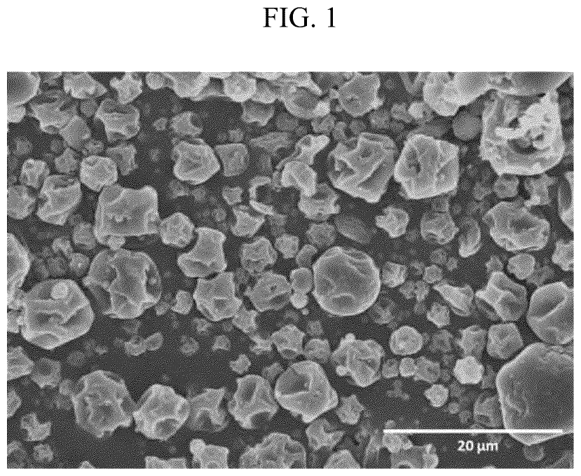

As a result, as disclosed in FIG. 1, it was confirmed that the powder particles of the microencapsulated spray drying formulation of Btk IMBL-B9 showed a partially collapsed small spherical shape with a size of 5˜7 m.

### Example 2. Stability of Microencapsulated Spray Drying Formulation of Btk IMBL-B9

The survival rate of spores according to encapsulation was evaluated for the microencapsulated spray drying formulation of Btk IMBL-B9 and the non-encapsulated spray drying samples.

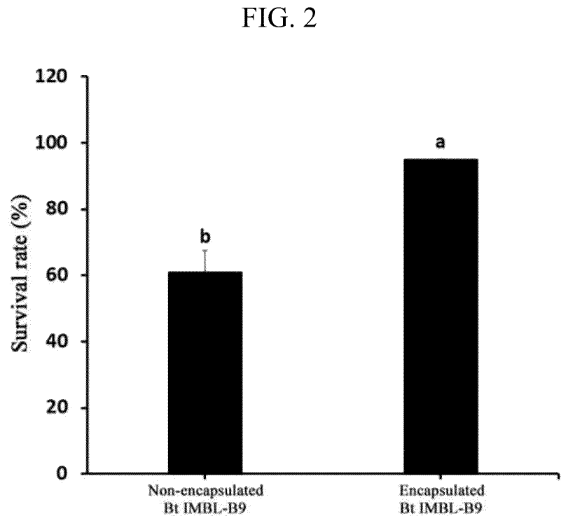

As a result, it was confirmed that the effective cell count of the microencapsulated spray drying formulation of Btk IMBL-B9 after the spray-drying process by coating it with a mixture of gum arabic, starch and maltodextrin was 2.02×10¹⁰ CFU/g and the survival rate was 95%. In contrast, in the case of the non-encapsulated spray drying formulation, the effective bacterial count after the spray drying process was 2.23×10¹⁰ CFU/g, and the spore viability was 61% (FIG. 2).

Based on these results, it was confirmed that the method of coating the spore-crystal complex with a mixture of gum arabic, starch, and maltodextrin and then spray-drying can reduce the high temperature effect through microencapsulation, thereby increasing the stability of the endospores of Btk IMBL-B9.

TABLE 1
Stability of formulations of encapsulated and non-encapsulated
spray drying formulations of Btk IMBL-B9s and commercially available
bioinsecticide XenTari ® during storage at 54 ± 2° C.

| Storage period | Colony forming units (CFUg⁻¹) | | |
|---|---|---|---|
| (weeks at | Non-encapsulated | Eencapsulated | |
| 54 ± 2° C.) | BtK IMBL-B9 | BtK IMBL-B9 | XenTari ® |
| 0 | 2.23 × 10^{10c} | 2.02 × 10^{10c} | 6.90 × 10^{10a} |
| 2 | 1.58 × 10^{10b} | 1.78 × 10^{10bc} | 6.31 × 10^{10a} |
| 4 | 3.78 × 10^{9a} | 1.67 × 10^{10bc} | 5.95 × 10^{10a} |
| 6 | 2.72 × 10^{9a} | 1.16 × 10^{10a} | 4.26 × 10^{10a} |

The averages of each column with different lowercase superscripts indicates statistical significance (p<0.05).

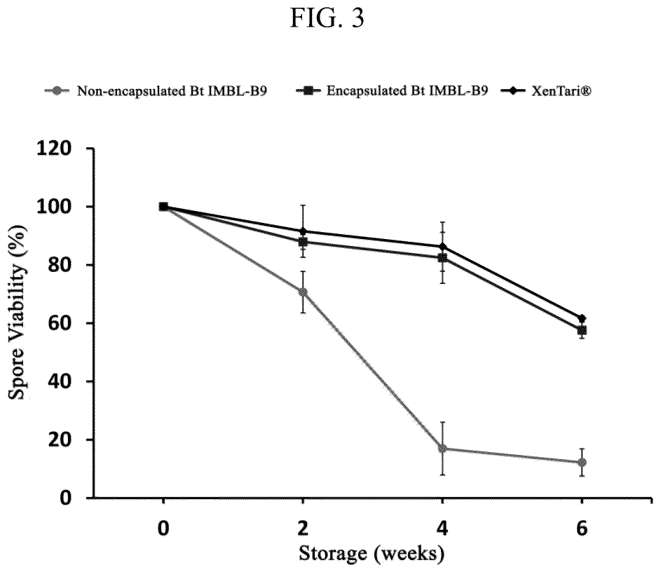

In addition, in order to investigate the stability over time due to the effect of microencapsulation, the encapsulated and non-encapsulated spray drying formulations of Btk IMBL-B9s and commercially available Bt insecticide XenTari® as the positive control group were stored at 54° C. for 6 weeks, and the spore survival rate was investigated at storage intervals of 0, 2, 4, and 6 weeks. After 6 weeks of storage, the spore survival rate of the encapsulated spray drying formulation of Btk IMBL-B9 was confirmed to be 57.6%, which was similar to the spore survival rate of Bt insecticide XenTari® as the positive control group, which was 61.7%. In contrast, the non-encapsulated spray drying formulation of Btk IMBL-B9 showed a very low spore survival rate of 12.2% (Table 1 and FIG. 3).

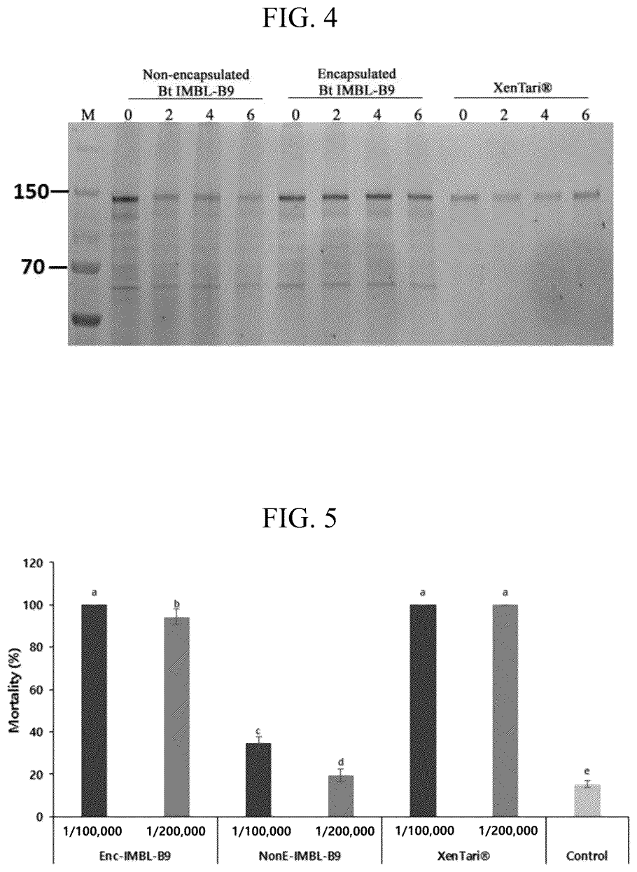

Meanwhile, the contents of an insecticidally active crystal protein Cry in the encapsulated and non-encapsulated spray drying formulation of Btk IMBL-B9s stored for 0, 2, 4, and 6 weeks at 54±2° C. and the commercially available Bt insecticide XenTari® as a positive control were analyzed by SDS-PAGE. As a result, as shown in FIG. 4, the encapsulated spray drying formulation of Btk IMBL-B9 of the present invention showed a high concentration of bands of insecticidally active crystal protein corresponding to molecular weights of 130 and 65 kDa in all of the 0- to 6-week storage loading samples, and the results of the positive control XenTari® were similar. On the other hand, the non-encapsulated spray drying formulation of Btk IMBL-B9 showed a gradually decreasing concentration of the insecticidally active crystal protein as a loading sample with a long storage period of 6 weeks.

### Example 3. Biological Assay of Microencapsulated Spray Drying Formulation of Btk IMBL-B9

The insecticidal activity of the microencapsulated spray drying formulation of Btk IMBL-B9 and the non-encapsulated spray drying formulation stored at 54±2° C. for 6 weeks, and the commercially available Bt insecticide XenTari® diluted by 1/100,000 and 1/200,000 times as a positive control, against the seven-year-old larvae of Plutella xylostella was investigated. As a result, as shown in FIG. 5, the microencapsulated spray drying formulation of Btk IMBL-B9s diluted by 1/100,000 and 1/200,000 times showed high mortality rates of 100% and 95%, respectively, and XenTari® as the positive control group also showed 100% insecticidal activity. On the other hand, the non-encapsulated spray drying formulation of Btk IMBL-B9 showed very low mortality rates.

### Example 4. Evaluation of Moth-Controlling Efficacy of Microencapsulated Spray Drying Formulation of Btk IMBL-B9 in a Greenhouse

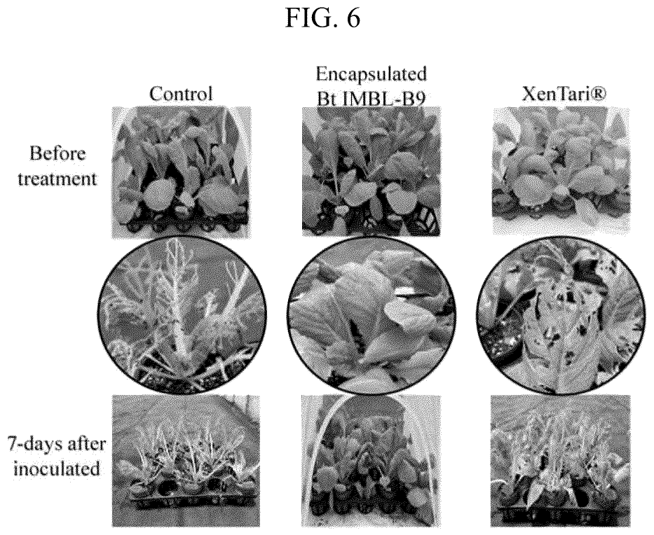

In order to evaluate the insecticidal activity of the microencapsulated spray drying formulation of Btk IMBL-B9 in an actual agricultural environment, a greenhouse experiment was conducted using cabbage and cucumber plant ports to control polyphagous pests Plutella xylostella and Spodoptera frugiperda. An experiment was conducted to evaluate the controlling efficacy of Plutella xylostella and Spodoptera frugiperda using cabbage plant pots. As a result, as shown in FIG. 6, it was confirmed that the untreated group and the positive control group XenTari® showed more than 80% leaf damage. On the other hand, the microencapsulated Btk IMBL-B9 formulation-treated group of the present invention showed almost no damage to the leaves, demonstrating that the combined pest controlling efficacy of Plutella xylostella and Spodoptera frugiperda was very excellent compared to that of the positive control group XenTari®.

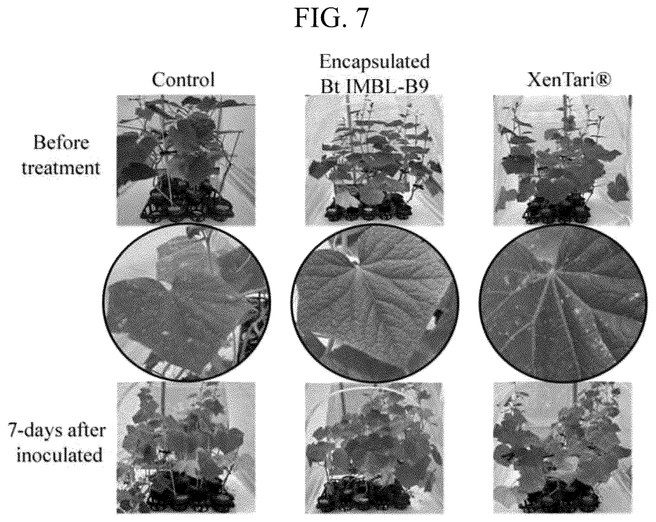

In addition, an experiment was conducted to evaluate the control efficacy of Spodoptera frugiperda using cucumber plant pots. As a result, as shown in FIG. 7, in the untreated group and the positive control group XenTari® treated group, Spodoptera frugiperda continuously damaged the leaves, and food marks were observed, but in the microencapsulated Btk IMBL-B9 formulation-treated group of the present invention, the Spodoptera frugiperda insecticidal rate was 100%, and no damage to the leaves was observed at all, demonstrating that the single pest controlling efficacy of Spodoptera frugiperda was superior to that of the positive control group XenTari®, and confirming that the moth controlling efficacy of the microencapsulated spray drying formulation of Btk IMBL-B9 was very excellent.

What is claimed is:

1. A microencapsulation-based spray drying formulation which is prepared by fermenting a Bacillus thuringiensis subsp. kurstaki IMBL-B9 strain to obtain a fermentation liquid, collecting a spore-crystal complex from the fermentation liquid, concentrating it, adding a coating mixture consisting of gum arabic, starch and maltodextrin to the concentrated spore-crystal complex, followed by stirring and spray drying.

2. The microencapsulation-based spray drying formulation according to claim 1, wherein the coating mixture is a mixture of gum arabic, starch and maltodextrin in a weight ratio of 0.5˜10.0:0.5˜10.0:0.5˜10.0.

3. The microencapsulation-based spray drying formulation according to claim 1, wherein the spray drying is carried out using a spray drying device at an inlet temperature of 130˜150° C. and an outlet temperature of 80˜90° C.

4. A composition for controlling Spodoptera frugiperda or Plutella xylostella, comprising the microencapsulation-based spray drying formulation of claim 1 as an active ingredient.

5. A composition for controlling Spodoptera frugiperda or Plutella xylostella, comprising the microencapsulation-based spray drying formulation of claim 2 as an active ingredient.

6. A composition for controlling Spodoptera frugiperda or Plutella xylostella, comprising the microencapsulation-based spray drying formulation of claim 3 as an active ingredient.

7. A method for controlling Spodoptera frugiperda or Plutella xylostella, comprising treating an effective amount of the composition for controlling Spodoptera frugiperda or Plutella xylostella of claim 4 to a plant, a plant seed, or a cultivation area.

8. A method for controlling Spodoptera frugiperda or Plutella xylostella, comprising treating an effective amount of the composition for controlling Spodoptera frugiperda or Plutella xylostella of claim 5 to a plant, a plant seed, or a cultivation area.

9. A method for controlling Spodoptera frugiperda or Plutella xylostella, comprising treating an effective amount of the composition for controlling Spodoptera frugiperda or Plutella xylostella of claim 6 to a plant, a plant seed, or a cultivation area.

10. A method for preparing a microencapsulation-based spray drying formulation, the method comprising:
(1) a step of fermenting a Bacillus thuringiensis subsp. kurstaki IMBL-B9 strain to obtain a fermentation liquid, collecting a spore-crystal complex from the fermentation liquid, and concentrating it;
(2) a step of adding a coating mixture of gum arabic, starch and maltodextrin in a weight ratio of 0.5˜10.0:0.5˜10.0:0.5˜10.0 to the concentrated spore-crystal complex, and stirring the mixture; and
(3) a step of spray-drying the resulting mixture using a spray drying device at an inlet temperature of 130˜150° C. and an outlet temperature of 80˜90° C., after the stirring.
